(19) United States
(12) Patent Application Publication
(10) Pub. No.: US 2017/0083154 A1
(43) Pub. Date: Mar. 23, 2017

(54) INFORMATION PROCESSING APPARATUS, INFORMATION PROCESSING METHOD, AND INFORMATION PROCESSING PROGRAM

(71) Applicant: NEC Corporation, Minato-ku, Tokyo (JP)

(72) Inventors: Hotaka SUGANO, Tokyo (JP); Tatsushi YASUDA, Tokyo (JP); Satoru ISHII, Tokyo (JP)

(73) Assignee: NEC Corporation, Minato-ku, Tokyo (JP)

(21) Appl. No.: 15/126,439

(22) PCT Filed: Dec. 22, 2014
(86) PCT No.: PCT/JP2014/083983

§ 371 Date: Sep. 15, 2016

(30) Foreign Application Priority Data
Mar. 20, 2014 (JP) 2014-059238

(51) Int. Cl. G06F 3/041; G06F 3/0488

(52) U.S. Cl. CPC G06F 3/0418; G06F 3/0412; G06F 3/0488; G06F 3/04842

(57) ABSTRACT

An apparatus according to this invention is directed to an information processing apparatus that generates a designated region even if the locus of a user operation does not fit in a touch panel. The information processing apparatus includes a stroke acquirer that acquires a stroke from a user operation on a touch panel, a detector that detects that a finger locus of a user on drawing the stroke extends outside the touch panel, and a complementer that complements the stroke outside the touch panel when the finger locus of the user is estimated to draw a closed region.

### TECHNICAL FIELD

The present invention relates to an information processing apparatus, an information processing method, and an information processing program.

### BACKGROUND ART

In the above technical field, patent literature 1 discloses a technique of selecting a paragraph, sentence, phrase, or word designated by the user by circling, with a finger, a partial region on the touch panel of a smartphone or tablet.

### CITATION LIST

### Patent Literature

Patent literature 1: Japanese Patent Laid-Open No. 2013-186720

### SUMMARY OF THE INVENTION

### Technical Problem

In the technique described in the above literature, however, if a stroke from a touch to a release by the user temporarily extends outside a region of a touch panel, a selected range cannot be generated.

The present invention enables to provide a technique of solving the above-described problem.

### Solution to Problem

One aspect of the present invention provides an information processing apparatus comprising:

a stroke acquirer that acquires a stroke from a user operation on a touch panel;

a detector that detects that a finger locus of a user on drawing the stroke extends outside the touch panel; and

a complementer that complements the stroke outside the touch panel when the finger locus of the user is estimated to draw a closed region.

Another aspect of the present invention provides another information processing apparatus comprising:

a stroke acquirer that acquires at least two strokes from user operations on a touch panel;

a determiner that determines, based on the at least two strokes, whether a finger of a user has moved outside a region of the touch panel and returned to the region of the touch panel;

a connector that connects the at least two strokes if the determiner determines that the finger of the user has moved outside the region of the touch panel and returned to the region of the touch panel; and

a selected range generator that generates a selected range based on a stroke generated by the connector.

Still other aspect of the present invention provides a method comprising:

acquiring a stroke from a user operation on a touch panel;

detecting that the stroke extends outside the touch panel; and

complementing the stroke outside the touch panel when the stroke is estimated to draw a closed region.

Still other aspect of the present invention provides another method, comprising:

acquiring at least two strokes from a touch to a release by a user on a touch panel;

determining, based on the at least two strokes, whether a finger of the user has moved outside a region of the touch panel and returned to the region of the touch panel to draw a closed region; and

connecting the at least two strokes if it is determined in said determining step that the finger of the user has moved outside the region of the touch panel and returned to the region of the touch panel to draw the closed region.

Still other aspect of the present invention provides a program for causing a computer to execute a method, comprising:

acquiring a stroke from a user operation on a touch panel;

detecting that the stroke extends outside the touch panel; and

complementing the stroke outside the touch panel when the stroke is estimated to draw a closed region.

Still other aspect of the present invention provides another program for causing a computer to execute a method, comprising:

acquiring at least two strokes from a touch to a release by a user on a touch panel;

determining, based on the at least two strokes, whether a finger of the user has moved outside a region of the touch panel and returned to the region of the touch panel to draw a closed region; and

connecting the at least two strokes if it is determined in said determining step that the finger of the user has moved outside the region of the touch panel and returned to the region of the touch panel to draw the closed region.

### Advantageous Effects of Invention

According to the present invention, even if a stroke from a touch to a release by the user extends outside a region of a touch panel, it is possible to generate a selected range.

### BRIEF DESCRIPTION OF DRAWINGS

FIG. 1A is a block diagram showing the arrangement of an information processing apparatus according to the first embodiment of the present invention;

FIG. 1B is a block diagram showing the arrangement of an information processing apparatus according to the second embodiment of the present invention;

FIG. 2 is a view showing an overview of stroke connection by an information processing apparatus according to the third embodiment of the present invention;

FIG. 3 is a view showing an overview of stroke connection by the information processing apparatus according to the third embodiment of the present invention;

FIG. 4A is a view showing the outer appearance of the information processing apparatus according to the third embodiment of the present invention;

FIG. 4B is a block diagram showing the arrangement of the information processing apparatus according to the third embodiment of the present invention;

FIG. 5 is a block diagram showing the functional arrangement of a screen operation processor according to the third embodiment of the present invention;

FIG. 6 is a block diagram showing the functional arrangement of an operation acceptor according to the third embodiment of the present invention;

FIG. 7 is a block diagram showing the functional arrangement of an operation analyzer according to the third embodiment of the present invention;

FIG. 8A is a block diagram showing the functional arrangement of a user operation determiner according to the third embodiment of the present invention;

FIG. 8B is a table showing the structure of a closed region estimation table according to the third embodiment of the present invention;

FIG. 8C is a table showing the structure of a stroke connection table according to the third embodiment of the present invention;

FIG. 9 is a block diagram showing the functional arrangement of a display controller according to the third embodiment of the present invention;

FIG. 10 is a block diagram showing the functional arrangement of a selected range setting unit according to the third embodiment of the present invention;

FIG. 11 is a flowchart illustrating the procedure of screen operation processing by the information processing apparatus according to the third embodiment of the present invention;

FIG. 12 is a flowchart illustrating the procedure of stroke connection processing according to the third embodiment of the present invention;

FIG. 13 is a view showing an overview of stroke connection by an information processing apparatus according to the fourth embodiment of the present invention;

FIG. 14 is a table showing the structure of a stroke connection table according to the fourth embodiment of the present invention;

FIG. 15 is a flowchart illustrating the procedure of stroke connection processing according to the fourth embodiment of the present invention;

FIG. 16 is a view showing an overview of stroke connection by an information processing apparatus according to the fifth embodiment of the present invention;

FIG. 17 is a table showing the structure of a stroke connection table according to the fifth embodiment of the present invention; and

FIG. 18 is a flowchart illustrating the procedure of stroke connection processing according to the fifth embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise. Note that “stroke” will indicate a locus from a touch to a release on a touch panel hereinafter.

### First Embodiment

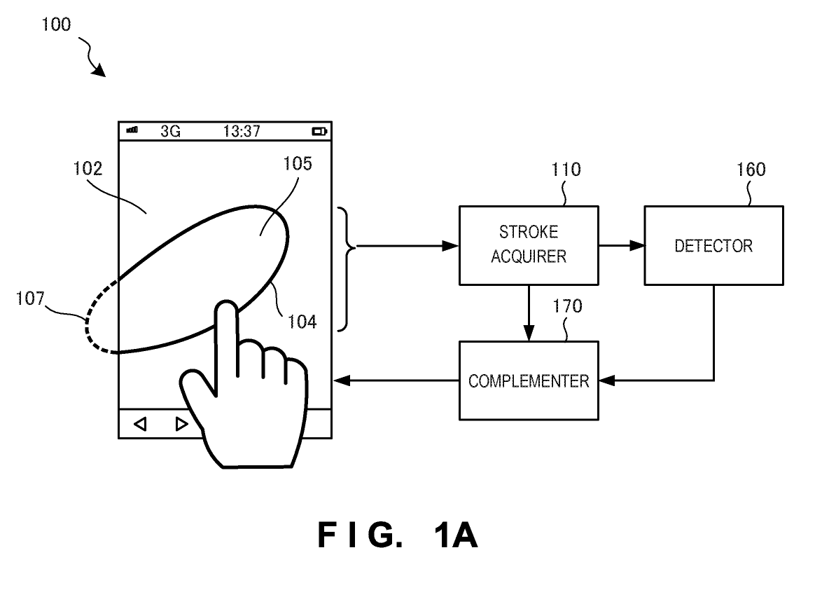

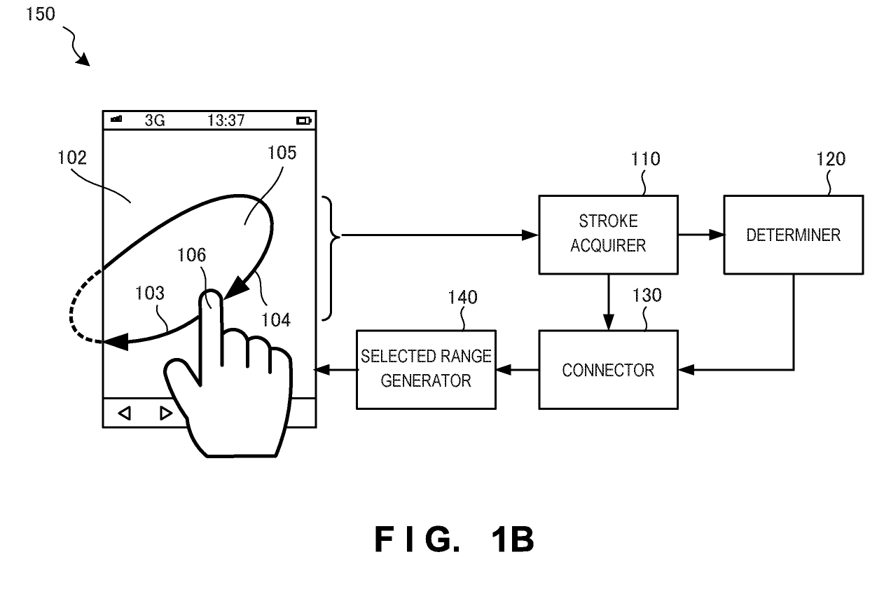

An information processing apparatus 100 according to the first embodiment of the present invention will be described with reference to FIG. 1A. The information processing apparatus 100 is an apparatus for controlling an input from a touch panel 102. As shown in FIG. 1A, the information processing apparatus 100 includes a stroke acquirer 110, a detector 160, and a complementer 170. The stroke acquirer 110 acquires a stroke 104 of a user operation on the touch panel 102. The detector 160 detects that the stroke 104 has left the touch panel 102. If the stroke 104 is estimated to draw a closed region, the complementer 170 complements a stroke 107 falling outside the touch panel 102.

For example, the detector 160 detects that a user's finger drawing the stroke 104 has moved outside the touch panel 102, estimates the movement of the finger outside the region of the touch panel 102, and complements, when the stroke returns to the touch panel 102, a portion between two points of the stroke on the touch panel 102.

According to this embodiment, by complementing a stroke falling outside the touch panel, it is possible to generate a designated region even if a user operation is not performed only within a display screen.

### Second Embodiment

An information processing apparatus 150 according to the second embodiment of the present invention will be described with reference to FIG. 1B. The information processing apparatus 150 is an apparatus for controlling an input from a touch panel 102.

As shown in FIG. 1B, the information processing apparatus 150 includes a stroke acquirer 110, a determiner 120, and a connector 130. The stroke acquirer 110 acquires at least two strokes 103 and 104 from a touch to a release by the user on the touch panel 102. Based on the at least two strokes 103 and 104, the determiner 120 determines whether a user's finger 106 has moved outside a region of the touch panel 102 and returned to the region of the touch panel 102. If the determiner 120 determines that the user's finger 106 has moved outside the region of the touch panel 102 and returned to the region of the touch panel 102, the connector 130 connects the strokes 103 and 104. A selected range generator 140 generates a selected range 105 based on a stroke generated by the connector 130.

For example, the stroke acquirer 110 acquires a leftward stroke from a touch near the center of the touch panel 102 to the left end portion of the touch panel 102, and acquires a stroke from the left end portion of the touch panel 102 to its right end portion. Based on, for example, the end portion positions, the vectors at the end portion, the leaving timing and return timing at the end portion, and the like of the strokes, the determiner 120 determines whether to connect the strokes. If, for example, the determiner 120 determines to connect the strokes, the connector 130 connects the two strokes by the generated new stroke. The selected range generator 140 generates, as a selected rage, a content (characters, words, sentences, or object graphics) included in a closed region surrounded by the stroke generated by connection.

According to this embodiment, by connecting a stroke falling outside the region of the touch panel to two strokes falling within the region of touch panel, it is possible to generate a selected range even if the stroke of the user extends outside the region of the touch panel.

### Third Embodiment

An information processing apparatus according to the third embodiment of the present invention will be described next. The information processing apparatus according to this embodiment generates, when a user's finger temporarily moves outside a region of a touch panel, one stroke to surround a closed region by connecting at least two separated strokes. If display contents do not fit in the touch panel (that is, display contents can be scrolled), a region which is not displayed can be included in a selected range by generating a virtual stroke outside a display region, and connecting it to the two strokes. Note that “the apparatus generates one stroke to surround a closed region by connecting at least two strokes” in this example. In other words, “to generate one stroke to surround a closed region, the apparatus complements a missing portion (a portion where the finger has moved outside the region of the touch panel)”.

<<Overview of Processing>>

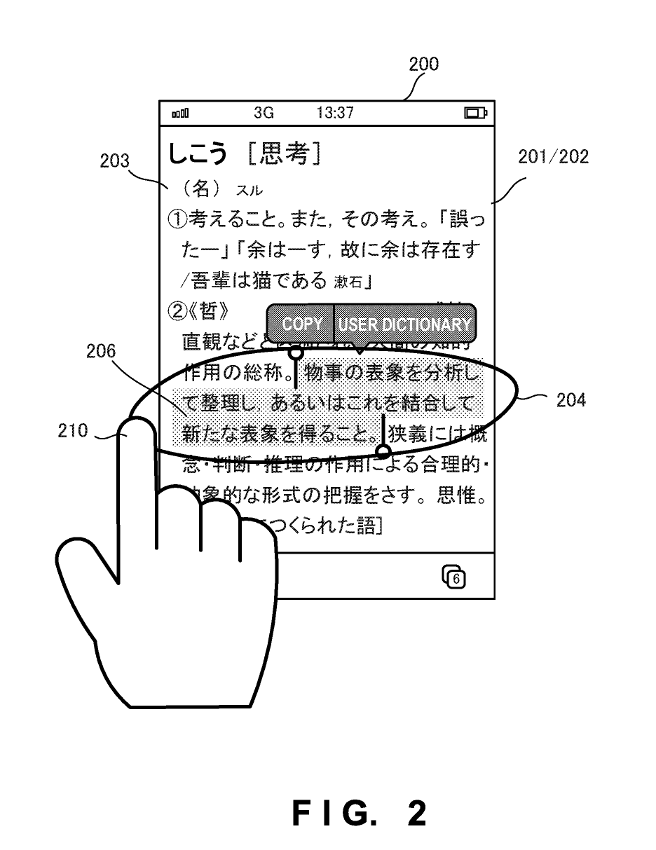

An overview of processing by the information processing apparatus according to this embodiment will be described below with reference to FIG. 2. FIG. 2 is a view showing an overview of stroke connection by an information processing apparatus 200 according to this embodiment.

A document 203 is displayed on a display panel 202 of the information processing apparatus 200. Assume that a user's finger 210 draws a finger locus 204 to designate a closed region but the finger locus 204 extends outside a region of a touch panel 201.

Even if the finger locus 204 extends outside the region of the touch panel 201, the information processing apparatus 200 estimates the finger locus 204, and sets a selected range 206. With this processing, even if the finger locus 204 extends outside the region of the touch panel 201, the selected range 206 desired by the user can be set.

<<Practical Example of Connection Processing>>

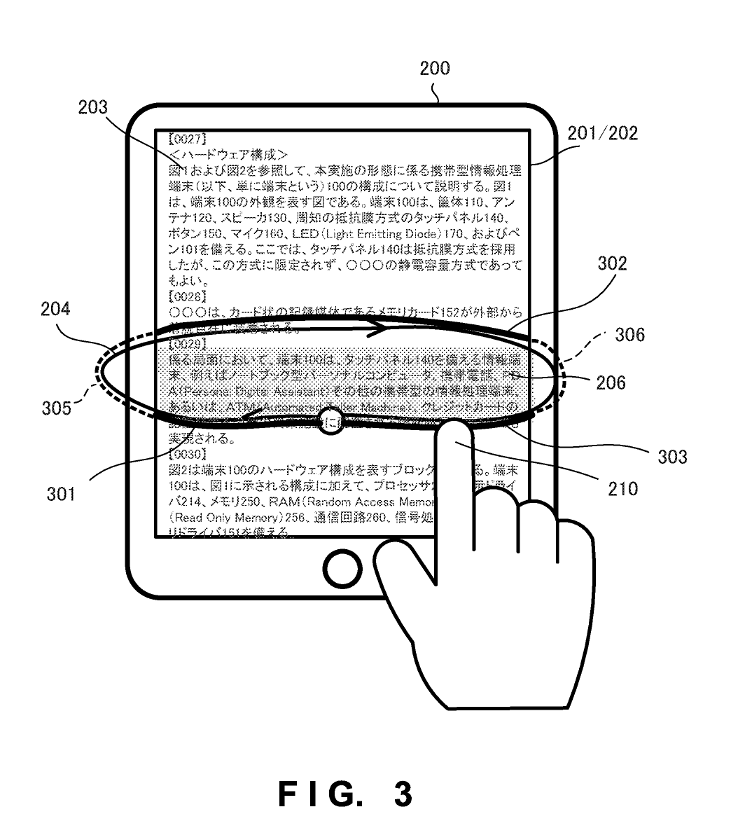

FIG. 3 is a view showing an overview of stroke connection by the information processing apparatus 200 according to this embodiment. FIG. 3 shows a case in which the entire width of display contents does not fit in the touch panel, and can be scrolled.

The document 203 is displayed on the display panel 202 of the information processing apparatus 200. Assume that the user's finger 210 draws, as a closed region, the finger locus 204 on the touch panel 201 to surround the selected range 206. This finger locus 204 extends outside the region of the touch panel 201.

The information processing apparatus 200 detects strokes 301 to 303, collectively analyzes their end portion positions, end portion vectors, and detection timings, and the like, and detects that the strokes are parts of the finger locus 204 surrounding the selected range 206. In this embodiment, one large stroke is generated by complementarily connecting virtual strokes 305 and 306 outside the region of the touch panel 201. If the large stroke draws a closed curve, the selected range 206 included in the closed curve is set. With this processing, even if the finger locus 204 extends outside the region of the touch panel 201, it is possible to set the selected range 206 desired by the user, and select information falling outside the touch panel.

<<Information Processing Apparatus>>

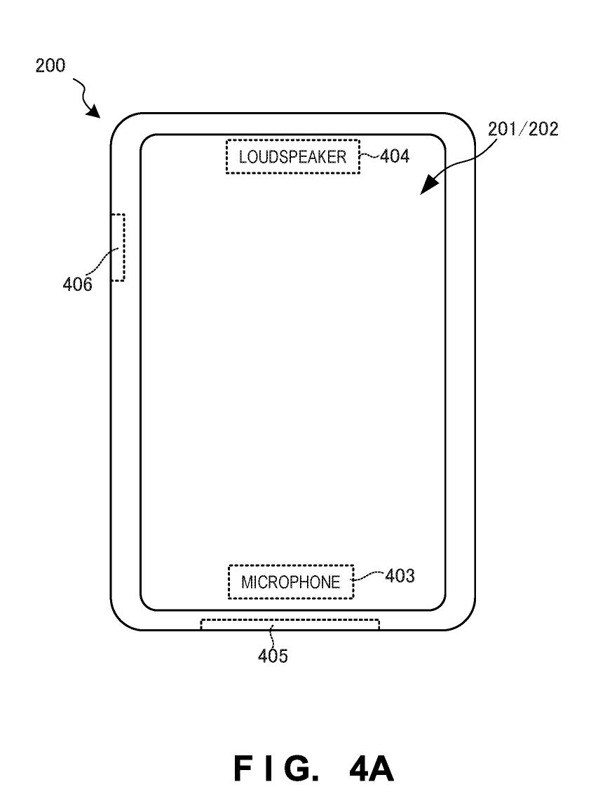

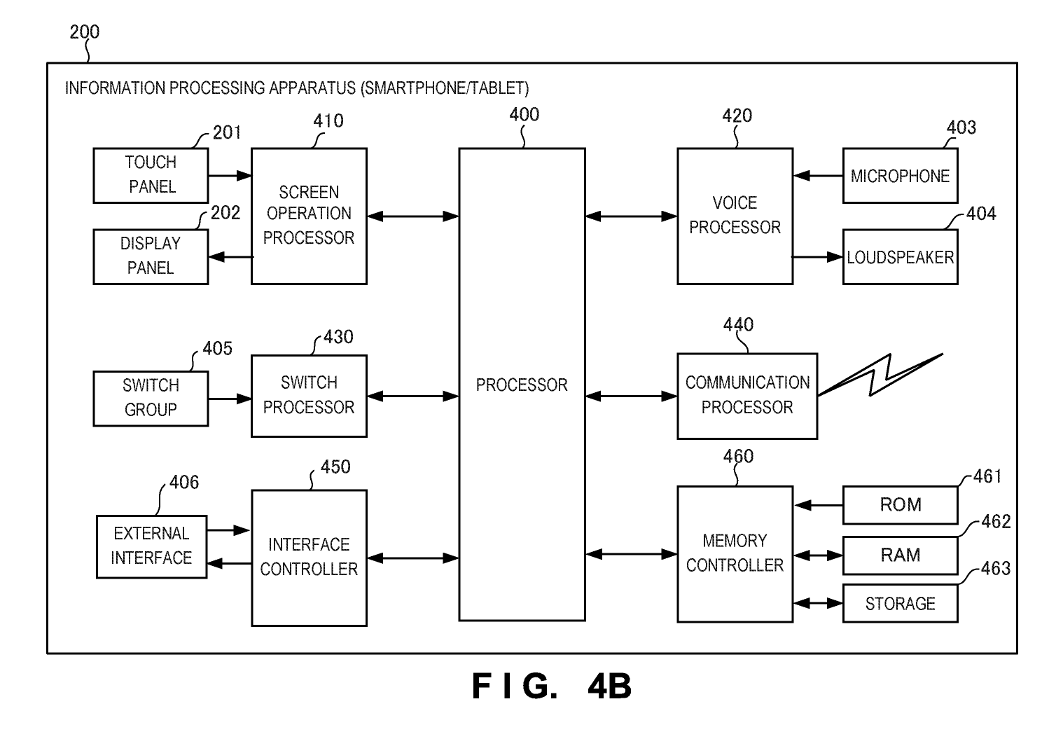

FIG. 4A is a view showing the outer appearance of the information processing apparatus 200 according to this embodiment. Note that FIG. 4A shows a terminal using a touch panel, such as a smartphone or tablet. However, the information processing apparatus according to this embodiment is not limited to the smartphone or tablet.

In the information processing apparatus 200, the touch panel 201 and the display panel 202 function as an operation unit and a display unit, respectively. The information processing apparatus 200 includes a microphone 403 and a loudspeaker 404 as a voice input/output function. The information processing apparatus 200 also includes a switch group 405 including a power switch. Furthermore, the information processing apparatus 200 includes an external interface 406 used for external input/output device connection and communication connection.

(Functional Arrangement of Information Processing Apparatus)

FIG. 4B is a block diagram showing the arrangement of the information processing apparatus 200 according to this embodiment. Note that FIG. 4B shows the basic arrangement of the portable terminal using the touch panel, such as a smartphone or tablet. The present invention, however, is not limited to this. Each component shown in FIG. 4B may be implemented by a single hardware component, software by including a proprietary processor to execute a program, or firmware by combining hardware and software. Each component shown in FIG. 4B is separated from other components to independently implement its function. In fact, however, each component is implemented by a combination of multilayer controls from bottom layer control by basic hardware and OS (Operating System) and input/output control to top layer control by an application program.

A processor 400 includes at least one CPU (Central Processing Unit), and controls the overall information processing apparatus 200. Note that the processor 400 desirably incorporates a unique memory. A screen operation processor 410 is a component for performing processing according to this embodiment. The screen operation processor 410 accepts a user operation input from the touch panel 201, changes a display screen in correspondence with the user operation input, and displays the screen on the display panel 202. Note that the screen operation processor 410 may be implemented by executing an associated program by the processor 400 but an independent screen operation processor is desirably provided. A voice processor 420 processes a voice input from the microphone 403 to, for example, transmit the voice input via a communication processor 440 or send a user voice instruction changed to a user operation input from the touch panel 201. The voice processor 420 generates a notification/warning to the user, a video reproduction voice, or the like, and outputs a voice from the loudspeaker. The voice processor 420 is also desirably provided with a voice processing processor independent of the processor 400.

A switch processor 430 executes processing based on a switch input from the switch group 405. The communication processor 440 transmits/receives data via a network. An interface controller 450 controls data input/output to/from an input/output device connected via the external interface 406. The communication processor 440 is also desirably provided with a voice processing processor independent of the processor 400. For example, a memory controller 460 controls exchange of data and programs between the processor 400 and a ROM (Read Only Memory) 461 which is formed by a flash memory and the like, a RAM (Random Access Memory) 462, and a storage 463. The memory controller 460 is also desirably provided with a voice processing processor independent of the processor 400.

(Screen Operation Processor)

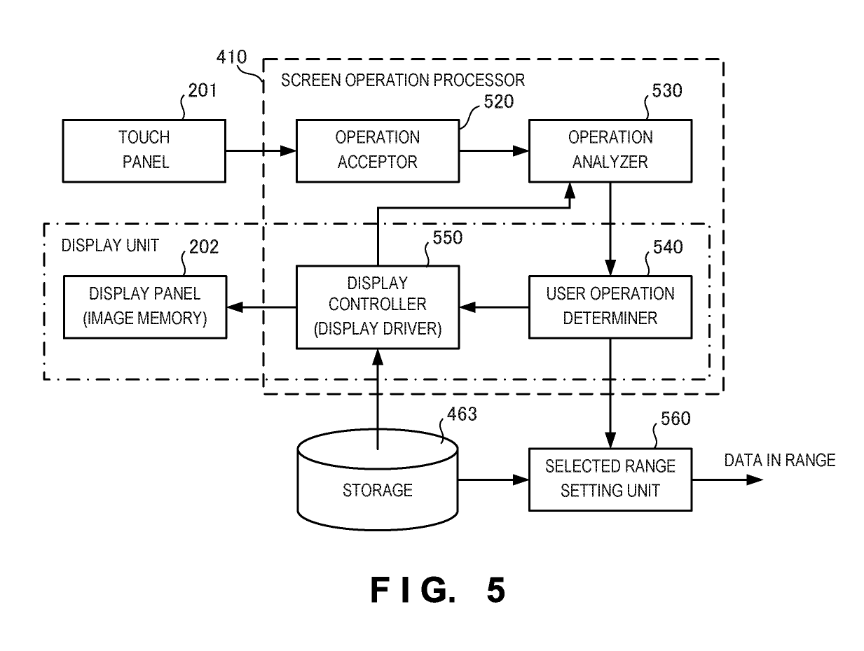

FIG. 5 is a block diagram showing the functional arrangement of the screen operation processor 410 according to this embodiment.

The screen operation processor 410 includes an operation acceptor 520, an operation analyzer 530, a user operation determiner 540, and a display controller 550. The operation acceptor 520 accepts a user operation from the touch panel 201, and acquires a touch position, an operation, and the like. The operation analyzer 530 analyzes operation contents in consideration of information of the display screen based on the user operation and position accepted by the operation acceptor 520. In this embodiment, the operation analyzer 530 especially acquires the end point of the stroke of the user if the stroke leaves the touch panel 201, and extracts the components of each stroke. For example, the operation analyzer 530 extracts a vector at the end point of the stroke. Based on the operation contents analyzed by the operation analyzer 530, the user operation determiner 540 estimates a drawing desired by the user. Furthermore, based on the operation contents analyzed by the operation analyzer 530, the user operation determiner 540 connects strokes within the touch panel region. The display controller 550 includes a display driver, and reads out content data from the storage 463 and controls the display panel 202 in accordance with the determination result of the user operation determiner 540.

A selected range setting unit 560 acquires and outputs data of the selected range in a display information DB 570 of the storage 463 based on a closed region drawn by the stroke derived by the user operation determiner 540.

Note that the functional components shown in FIG. 5 may be implemented by the processing of the processor of the screen operation processor 410, or some functional components may be processed by a proprietary processor to increase the processing speed. Each functional component shown in FIG. 5 is limited to the operation of the screen operation processor 410 but may exchange data with other components of the information processing apparatus 200 shown in FIG. 4B.

(Operation Acceptor)

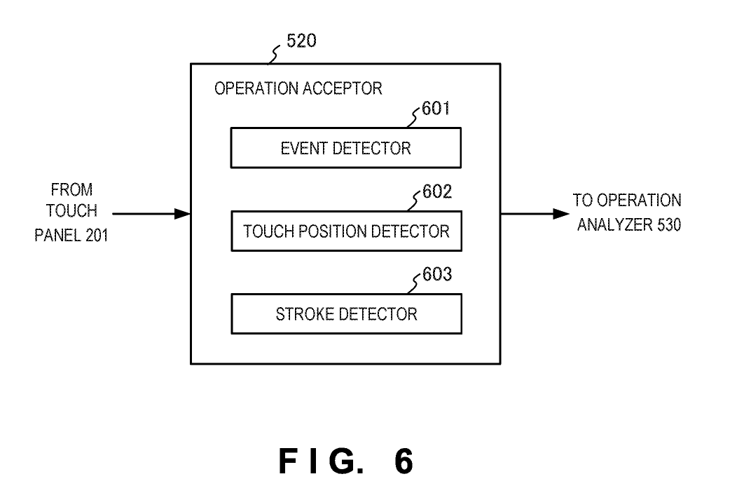

FIG. 6 is a block diagram showing the functional arrangement of the operation acceptor 520 according to this embodiment. The operation acceptor 520 accepts a user operation from the touch panel 201, and acquires a touch position and an operation.

The operation acceptor 520 includes an event detector 601, a touch position detector 602, and a stroke detector 603. The event detector 601 detects the start of some operation from the user on the touch panel 201, and starts accepting operation data. The touch position detector 602 detects position coordinates on the touch panel 201 touched by a user's finger. The stroke detector 603 detects a stroke based on a change in touch position.

(Operation Analyzer)

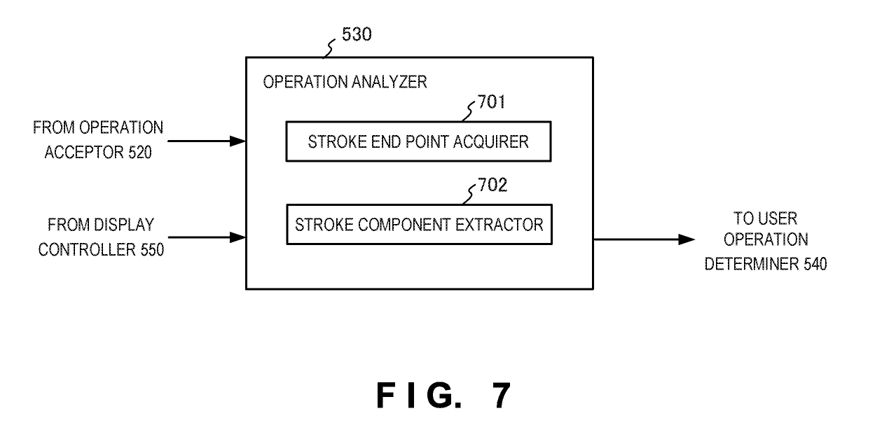

FIG. 7 is a block diagram showing the functional arrangement of the operation analyzer 530 according to this embodiment. The operation analyzer 530 analyzes operation contents in consideration of the information of the display screen based on the user operation and position accepted by the operation acceptor 520.

The operation analyzer 530 includes a stroke end point acquirer 701 and a stroke component extractor 702. The stroke end point acquirer 701 acquires, from the touch position data and stroke information from the operation acceptor 520, a leaving point at which the stroke leaves the touch panel and a return point at which the stroke returns to the touch panel. The stroke component extractor 702 extracts stroke information at the leaving and return points, for example, a tilt and the like. Note that in this embodiment, strokes are connected using both leaving and return points. The present invention, however, is not limited to this. One of leaving and return points may be used, or leaving and return points may be used in combination of other information.

(User Operation Determiner)

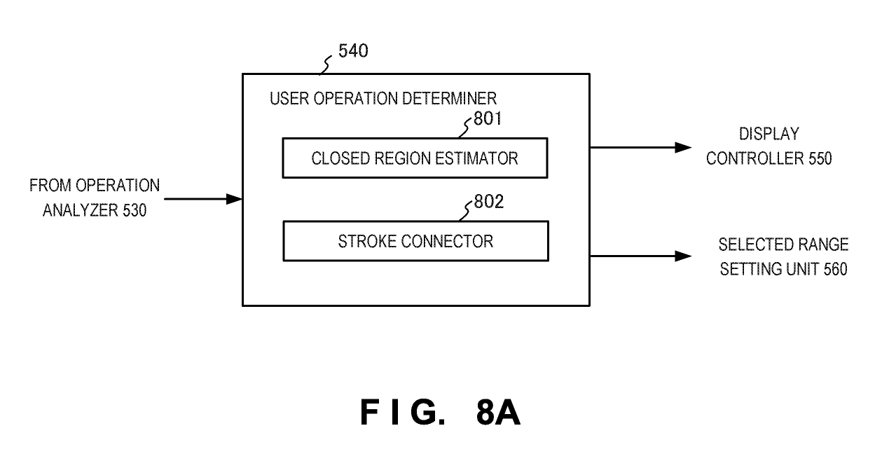

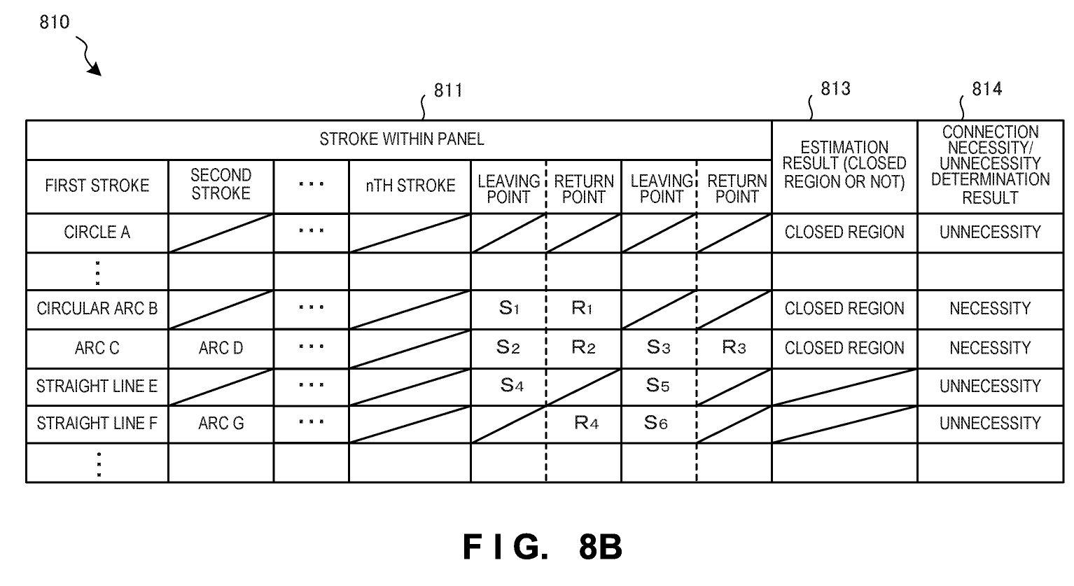

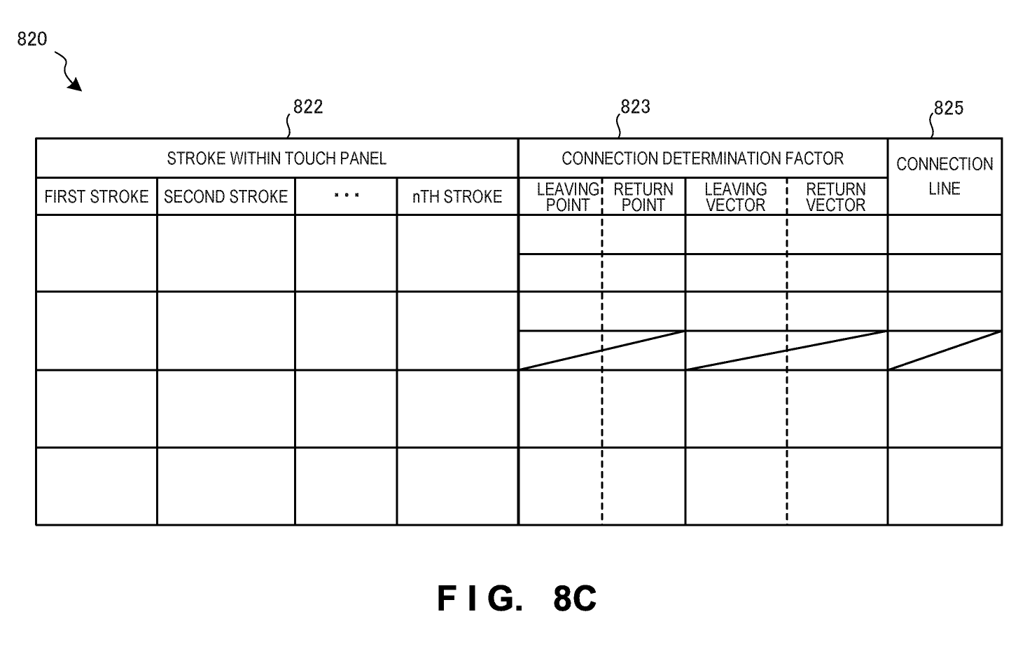

FIG. 8A is a block diagram showing the functional arrangement of the user operation determiner 540 according to this embodiment. The user operation determiner 540 estimates a drawing desired by the user based on the operation contents analyzed by the operation analyzer 530, thereby connecting strokes within the touch panel.

The user operation determiner 540 includes a closed region estimator 801 and a stroke connector 802. The closed region estimator 801 estimates a drawing by the user based on a closed region estimation table 810. In this embodiment, the closed region estimator 801 estimates that a closed region is drawn to set a selected range. Using the stroke information and the information of the leaving and return points, the stroke connector 802 connects a stroke falling outside the touch panel to the leaving and return points so as to generate the estimated closed region based on a stroke connection table 820.

FIG. 8B is a table showing the structure of the closed region estimation table 810 according to this embodiment. The closed region estimation table 810 is used by the closed region estimator 801 to estimate, based on a stroke drawn by the user, that the finger locus of the user has drawn a closed region.

The closed region estimation table 810 stores an estimation result 813 indicating whether a closed region has been drawn, and a connection necessity/unnecessity determination result 814, in association with stroke data 811 within the region of the touch panel and virtual stroke data 812 outside the region of the touch panel. As the stroke data 811, a pair of information of a leaving point at which a stroke leaves the touch panel and information of a return point at which the stroke returns to the touch panel is stored. Each of the pieces of information of the leaving and return points includes coordinates on the touch panel, the velocity vector of the stroke at each point, and a leaving timing or a return timing.

The closed region estimator 801 compares the start and end points of a stroke acquired within a predetermined time. If the positions of the start and end points of one stroke are close to each other (the distance between the positions is equal to or shorter than a predetermined one), it is determined that the one stroke forms a closed region, and this determination result is registered in the estimation result 813. Then, it is determined that connection is unnecessary, and this determination result is registered in a determination result 814. On the other hand, if there is no stroke having start and end point positions close to each other, the closed region estimator 801 extracts a set of strokes having start and end point positions close to each other, determines, for the set of strokes, whether another stroke should be connected to the strokes, based on the positions of leaving and return points, stroke directions, and leaving/return timings, and registers the determination result in the determination result 814. Especially, a connection condition is that the stroke directions are different from each other. That is, if there are leaving and return points at the left end, a connection condition is that a leftward stroke to the leaving point is followed by a rightward stroke from the return point. Furthermore, a closed region which can be formed by connecting another stroke to the strokes is estimated and registered in the estimation result 813.

FIG. 8C is a table showing the structure of the stroke connection table 820 according to this embodiment. The stroke connection table 820 is used by the stroke connector 802 to connect strokes within the touch panel when a stroke drawn by the user is estimated to form a closed region.

The stroke connection table 820 is a table used by the stroke connector 802 to determine a connection line for strokes which have been determined to be connected, based on the closed region estimation table 810. The stroke connection table 820 stores connection determination factors 823 in association with strokes 822 within the touch panel, which have been determined to be connected. The positions of leaving and return points, the distance between the leaving and return points, a leaving vector at the leaving point, a return vector at the return point, a leaving timing, a return timing, and the like are stored as the connection determination factors 823. Based on these pieces of information, it is determined whether to connect the leaving and return points. If it is determined to connect the leaving and return points, a connection line 825 is determined based on the distance between the leaving and return points and stroke directions at the respective points. As the connection line 825, for example, a quadratic or cubic curve, Bezier curve, parabola, spline curve, or the like can be used. However, the leaving and return points may be complementarily connected by a circular arc.

(Display Controller)

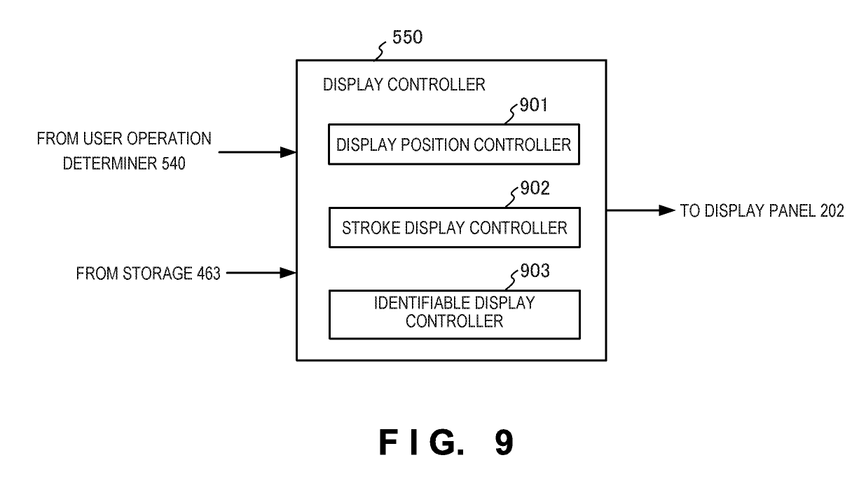

FIG. 9 is a block diagram showing the functional arrangement of the display controller 550 according to this embodiment. The display controller 550 includes a display driver, and reads out display information in the display information DB 570 and controls the screen of the display panel 202 by changing an image memory so as to implement, on the display screen, an operation desired by the user in accordance with the determination result of the user operation determiner 540. The display controller 550 includes a display position controller 901, a stroke display controller 902, and an identifiable display controller 903. The display position controller 901 controls a position of the display information read out from the display information DB 570 to be displayed. In this embodiment, the display position controller 901 controls the display position of the document. The stroke display controller 902 controls display of a stroke touched by the user. The identifiable display controller 903 controls to identifiably display the selected range of the document on the display screen.

(Selected Range Setting Unit)

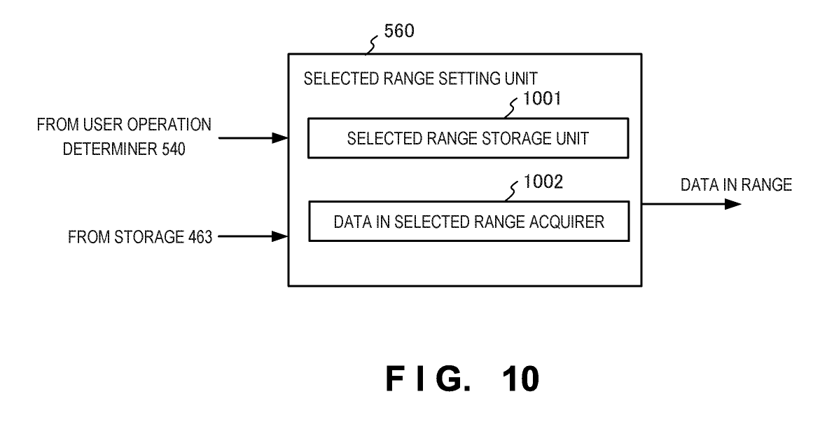

FIG. 10 is a block diagram showing the functional arrangement of the selected range setting unit 560 according to this embodiment. The selected range setting unit 560 acquires and outputs data of the selected range in the display information DB 570 based on a closed region drawn by the connected strokes from the user operation determiner 540.

The selected range setting unit 560 includes a selected range storage unit 1001 and a data in selected range acquirer 1002. The selected range storage unit 1001 stores, as a selected range, a closed region formed by strokes. The data in selected range acquirer 1002 acquires, from the display information DB 570, data of the selected range stored by the selected range storage unit 1001.

Note that the data of the selected range output from the selected range setting unit 560 is used for a copy/paste.

<<Procedure of Screen Operation Processing>>

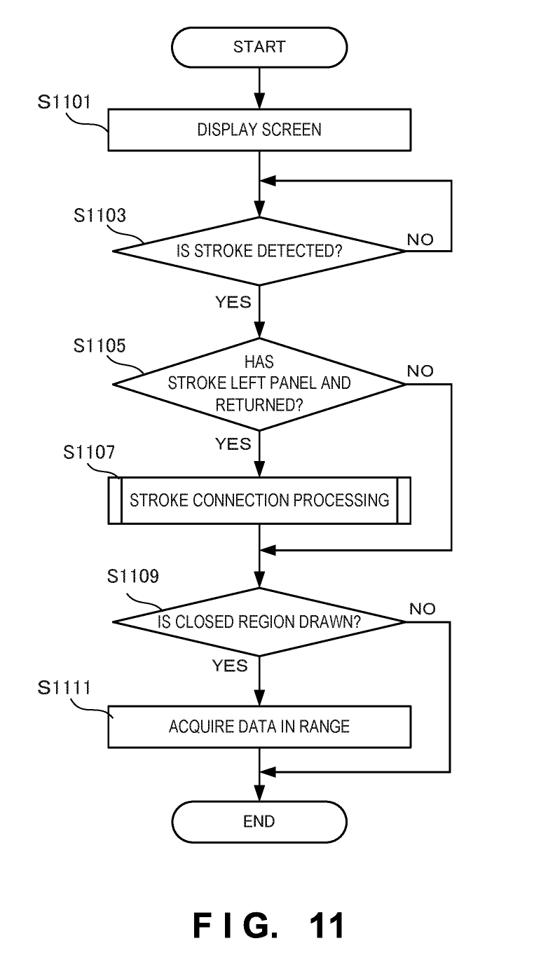

FIG. 11 is a flowchart illustrating the procedure of screen operation processing by the information processing apparatus 200 according to this embodiment. This flowchart implements the respective functional components of the screen operation processor 410 when executed by the processor 400 or the CPU of the screen operation processor 410. A case in which the CPU of the screen operation processor 410 executes the flowchart will be described.

In step S1101, the screen operation processor 410 displays a predetermined portion of a document designated, by the user, to be displayed. For example, as shown in FIG. 2, a page of “thought” of a Japanese dictionary is displayed. In step S1103, the screen operation processor 410 monitors whether the user touches the touch panel 201. If a touch is detected, the screen operation processor 410 determines in step S1105 whether the stroke of the user has temporarily left the touch panel and then returned. Whether the stroke has temporarily left the touch panel and then returned can be determined by monitoring leaving and return points.

If it is determined that the stroke has temporarily left and then returned, the screen operation processor 410 connects, in step S1107, a stroke having the leaving point as an end point and a stroke having the return point as a start point. The process advances to step S1109, and it is determined whether the strokes draw a closed region as a whole. This determination processing can be performed in accordance with FIG. 8A. If it is determined that the strokes draw a closed region, the screen operation processor 410 acquires, in step S1111, data included in a range of the closed region.

(Stroke Connection Processing)

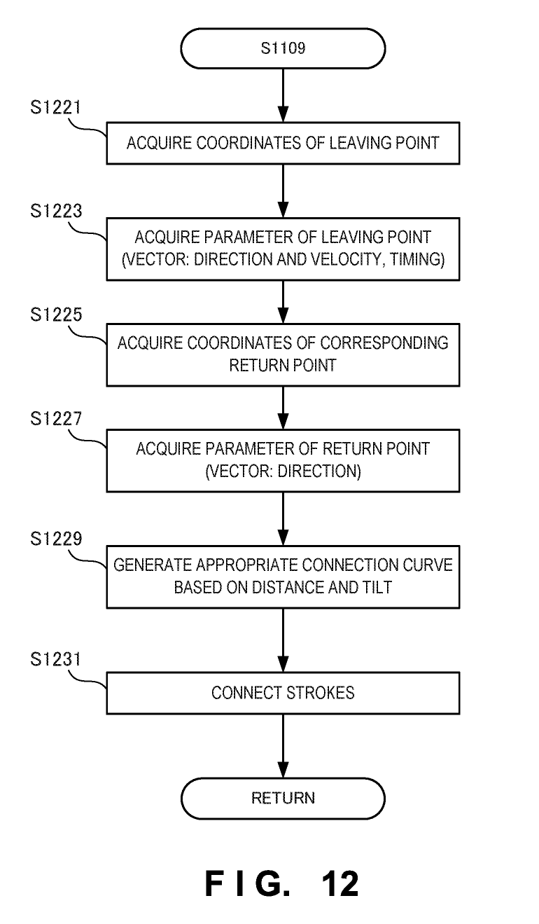

FIG. 12 is a flowchart illustrating the procedure of the stroke connection processing (S1109) according to this embodiment.

In step S1221, the screen operation processor 410 acquires the coordinates of the leaving point. In step S1223, the screen operation processor 410 acquires a parameter of the leaving point, for example, the tilt of the stroke. In step S1225, the screen operation processor 410 acquires the coordinates of the return point. In step S1227, the screen operation processor 410 acquires a parameter of the return point, for example, the vector (direction, velocity, and the like) of the stroke.

In step S1229, the screen operation processor 410 generates an appropriate connection curve based on the coordinates of the leaving and return points, the tilt of the stroke, and the like. For example, a circular arc which passes through the leaving and return points, and satisfies a leaving angle at the leaving point and a return angle at the return point is adopted as a connection curve. In step S1231, the screen operation processor 410 connects the connection curve to the other strokes.

According to this embodiment, since a stroke falling outside the touch panel is connected to the leaving and return points, even if a user operation is not performed only within the display screen, a selected range desired by the user can be generated.

### Fourth Embodiment

An information processing apparatus according to the fourth embodiment of the present invention will be described next. The information processing apparatus according to this embodiment is different from that according to the third embodiment in that a stroke along the frame of a touch panel is used as a connection stroke between strokes. The remaining components and operations are the same as those in the third embodiment. Hence, the same reference numerals denote the same components and operations, and a detailed description thereof will be omitted.

(Stroke Connection of Embodiment)

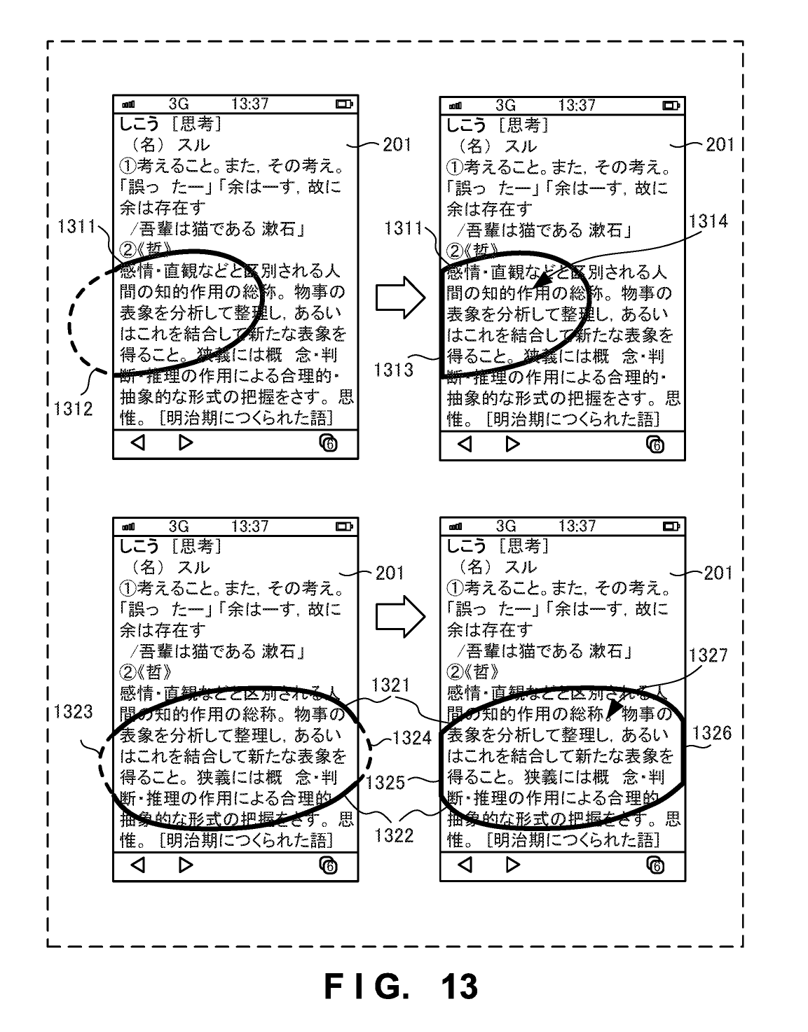

FIG. 13 is a view showing an overview of stroke connection by the information processing apparatus according to this embodiment. The upper portion of FIG. 13 shows processing when one side of a stroke extends outside a touch panel 201. The lower portion of FIG. 13 shows processing when two sides of a stroke extend outside the touch panel 201. Note that in FIG. 13, the same reference numerals denote the same components as in FIG. 2 or 3.

The upper left view of FIG. 13 shows a case in which a stroke drawn by the user is formed from a stroke 1311 falling within the touch panel 201 and a stroke 1312 falling outside the touch panel 201. The upper right view of FIG. 13 shows a case in which a closed region 1314 is formed as a selected range by connecting a stroke 1313 along the frame of the touch panel 201 to the stroke 1311, instead of the stroke 1312 falling outside the touch panel 201.

The lower left view of FIG. 13 shows a case in which a stroke drawn by the user is formed from strokes 1321 and 1322 falling within the touch panel 201 and strokes 1323 and 1324 falling outside the touch panel 201. The lower right view of FIG. 13 shows a case in which a closed region 1327 is formed as a selected range by connecting a stroke 1325 along the frame of the touch panel 201 to the strokes 1321 and 1322, instead of the stroke 1323 falling outside the touch panel 201, and connecting a stroke 1326 along the frame of the touch panel 201 to the strokes 1321 and 1322, instead of the stroke 1324 falling outside the touch panel 201.

As described above, even if a stroke drawn by the user extends outside the touch panel 201, it is possible to set a selected range by a closed region.

(User Operation Determiner)

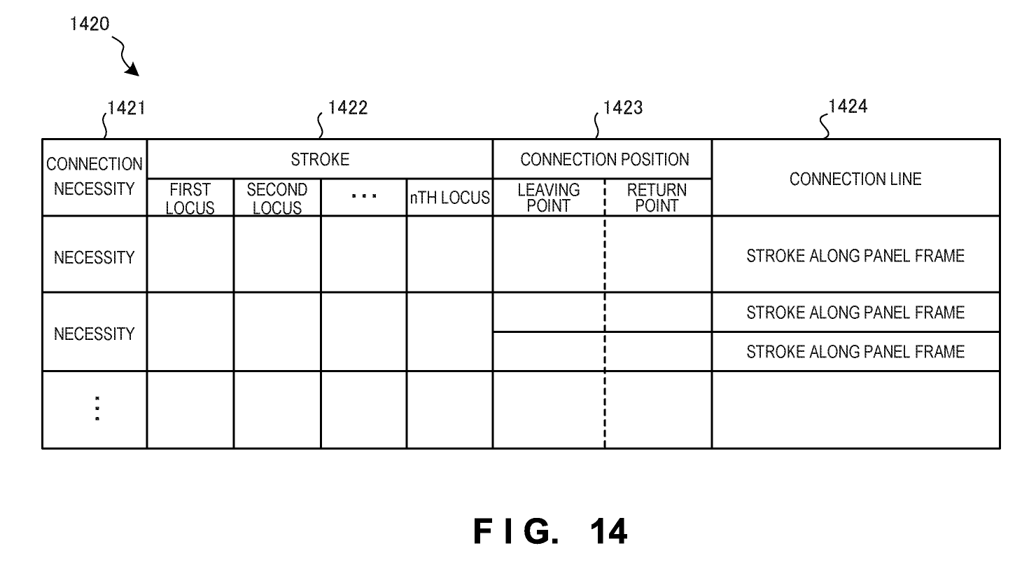

FIG. 14 is a table showing the structure of a stroke connection table 1420 according to this embodiment. The stroke connection table 1420 is used by a stroke connector 802 of a user operation determiner 540 to connect strokes within the touch panel 201.

The stroke connection table 1420 stores at least one connection position 1423 in association with each stroke 1422 within the touch panel of connection necessity 1421. The connection position 1423 stores leaving and return points. A stroke along the frame of the touch panel, which connects the leaving and return points, is used as a connection line 1424.

(Stroke Connection Processing)

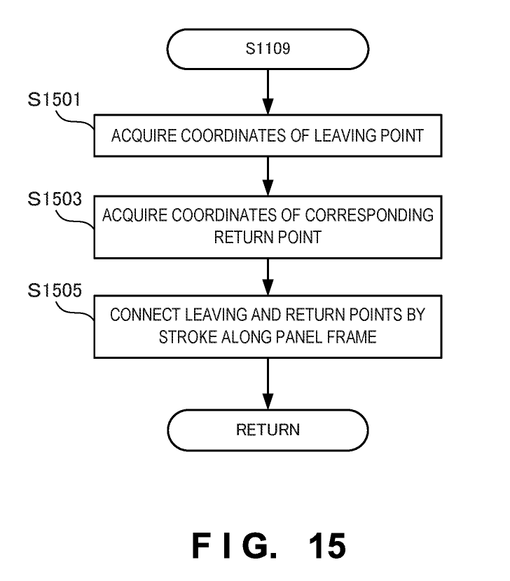

FIG. 15 is a flowchart illustrating the procedure of stroke connection processing (S1109) according to this embodiment.

In step S1501, a screen operation processor 410 acquires the coordinates of a leaving point. In step S1503, the screen operation processor 410 acquires the coordinates of a corresponding return point. In step S1505, the screen operation processor 410 connects the acquired leaving and return points, by a stroke along the frame of the touch panel, and sets a selected range as a closed region.

Note that in this embodiment, leaving and return points are connected by a touch panel frame to set a closed region. However, a closed region of a selected range can be set by excluding, from the touch panel region, a closed region formed by the touch panel frame and strokes within the touch panel.

According to this embodiment, since leaving and return points are connected by the touch panel frame, even if a user operation is not performed only within the display screen, a selected range desired by the user can be generated by simple processing. Note that stroke connection according to this embodiment is especially effective when display contents fall within the touch panel region.

### Fifth Embodiment

An information processing apparatus according to the fifth embodiment of the present invention will be described next. The information processing apparatus according to this embodiment is different from those according to the third and fourth embodiments in that the apparatus is formed from a plurality of touch panels and a plurality of display panels. The remaining components and operations are the same as those in the second or third embodiment. Hence, the same reference numerals denote the same components and operations, and a detailed description thereof will be omitted.

(Stroke Connection of Embodiment)

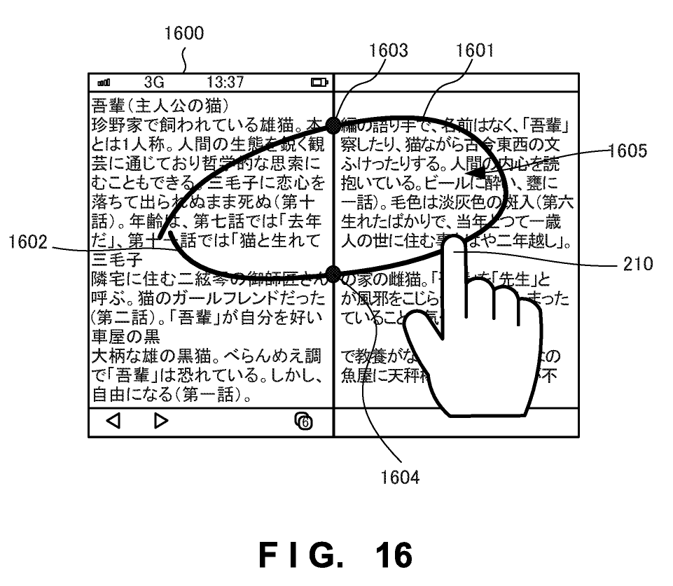

FIG. 16 is a view showing an overview of stroke connection by an information processing apparatus 1600 according to this embodiment. The information processing apparatus 1600 includes two touch panels/display panels.

Assume that a user's finger 210 draws strokes 1601 and 1602 to set a closed region across the two touch panels. The information processing apparatus 1600 can generate a closed region 1605 by connecting the strokes 1601 and 1602 at contact points 1603 and 1604 to complement each other, thereby setting a selected range.

(User Operation Determiner)

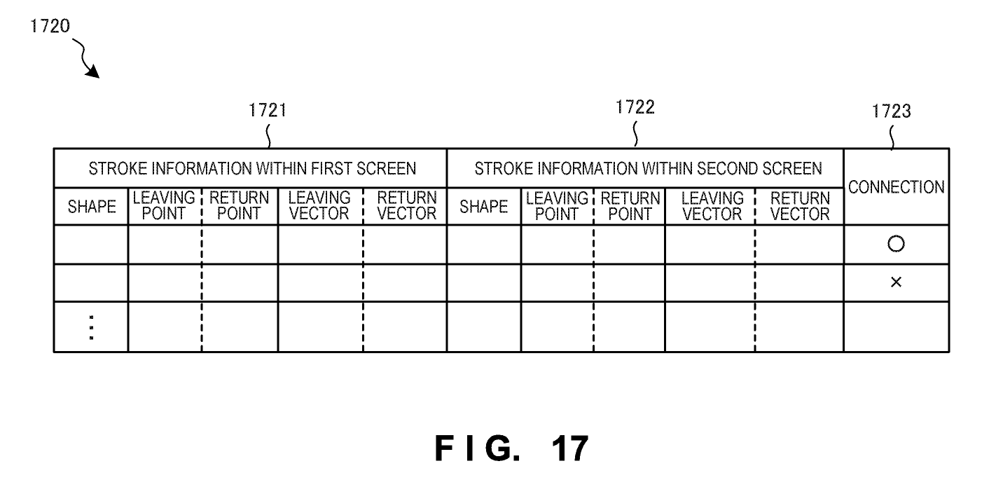

FIG. 17 is a table showing the structure of a stroke connection table 1720 according to this embodiment. The stroke connection table 1420 is used by a stroke connector 802 of a user operation determiner 540 to connect strokes on the two touch panels.

The stroke connection table 1720 stores a determination result 1723 indicating whether to connect strokes as a closed region, with reference to stroke information 1721 within the first screen (first touch panel) and stroke information 1722 within the second screen (second touch panel). Note that each piece 1721 or 1722 of stroke information includes information of the shape, leaving point, return point, leaving vector, and return vector of the stroke.

(Stroke Connection Processing)

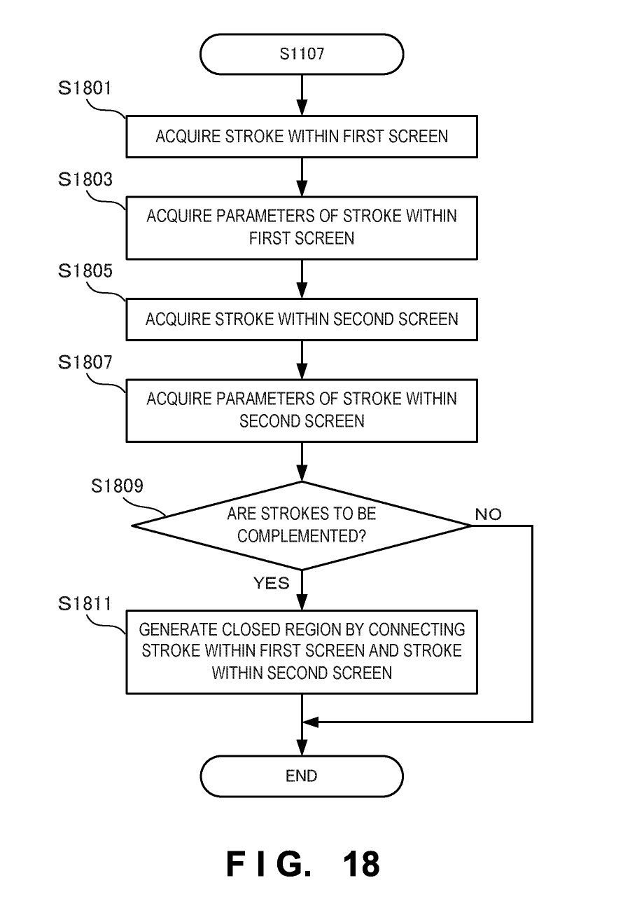

FIG. 18 is a flowchart illustrating the procedure of stroke connection processing (S1107) according to this embodiment.

In step S1801, a screen operation processor 410 acquires a stroke within the first screen (first touch panel). In step S1803, the screen operation processor 410 acquires parameters (leaving and return points, vectors at the points, and the like) of the stroke within the first screen (first touch panel). In step S1805, the screen operation processor 410 acquires a stroke within the second screen (second touch panel). In step S1807, the screen operation processor 410 acquires parameters (leaving and return points, vectors at the points, and the like) of the stroke within the second screen (second touch panel).

In step S1809, the screen operation processor 410 determines, based on the acquired information, whether to complement the strokes as a closed region. If it is determined to complement the strokes, the screen operation processor 410 sets, in step S1811, a selected range as a closed region by connecting the stroke within the first screen and that within the second screen at the same leaving and return points.

According to this embodiment, even if a user operation on a multi-screen is not performed only within one display screen, a selected range desired by the user can be generated.

### Other Embodiments

Note that the case of horizontal writing has been described in the above embodiments. However, the same technique can be applied to the case of vertical writing to obtain the same effects.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-059238 filed on Mar. 20, 2014, which is hereby incorporated by reference herein in its entirety.

What is claimed is:

1. An information processing apparatus comprising:
a stroke acquirer that acquires a stroke from a user operation on a touch panel;
a detector that detects that a finger locus of a user on drawing the stroke extends outside the touch panel; and
a complementer that complements the stroke outside the touch panel when the finger locus of the user is estimated to draw a closed region.

2. The information processing apparatus according to claim 1, wherein said complementer complements, by a predetermined curve, a portion between a leaving point of the stroke to the outside of the touch panel and a return point of the stroke to the inside of the touch panel.

3. The information processing apparatus according to claim 2, wherein the predetermined curve is generated based on information of the stroke at the leaving point and the return point.

4. The information processing apparatus according to claim 1 wherein said complementer complements, by a stroke along a frame of the touch panel, a portion between a leaving point of the stroke to the outside of the touch panel and a return point of the stroke to the inside of the touch panel.

5. The information processing apparatus according to claim 1, further comprising:
a setting unit that sets, as a selected range in a display document, the closed region drawn by the stroke complemented by said complementer.

6. The information processing apparatus according to claim 1, wherein
said stroke acquirer acquires at least two strokes from the user operation on the touch panel,
said detector has a determiner that determines, based on the at least two strokes, whether a finger of a user has moved outside a region of the touch panel and returned to the region of the touch panel,
said complementer has a connector that connects the at least two strokes if said determiner determines that the finger of the user has moved outside the region of the touch panel and returned to the region of the touch panel, and
further comprising a selected range generator that generates a selected range based on a stroke generated by said connector.

7. The information processing apparatus according to claim 6, wherein said connector connects, by a virtual stroke drawing a predetermined curve, a leaving point of one stroke to the outside of the region of the touch panel and a return point of another stroke to the inside of the region of the touch panel.

8. The information processing apparatus according to claim 7, wherein the predetermined curve is generated based on pieces of information of the strokes at the leaving point and the return point.

9. The information processing apparatus according to claim 8, wherein the predetermined curve is generated based on vectors of the strokes at the leaving point and the return point.

10. The information processing apparatus according to claim 6, wherein said connector connects, by a stroke along an end portion of the touch panel, a leaving point of one stroke to the outside of the touch panel and a return point of another stroke to the inside of the touch panel.

11. The information processing apparatus according to claim 6, wherein
said information processing apparatus includes at least two touch panels,
said determiner determines whether to connect the at least two strokes acquired from the at least two touch panels, and
said connector connects the at least two strokes on the at least two touch panels.

12. The information processing apparatus according to claim 6, further comprising:
a setting unit that sets, as a selected range in a display document, a closed region drawn by the stroke generated by said connector.

13. An information processing method comprising:
acquiring a stroke from a user operation on a touch panel;
detecting that the stroke extends outside the touch panel; and
complementing the stroke outside the touch panel when the stroke is estimated to draw a closed region.

14. (canceled)

15. A non-transitory computer-readable storage medium storing an information processing program for causing a computer to execute a method, comprising:
acquiring a stroke from a user operation on a touch panel;
detecting that the stroke extends outside the touch panel; and
complementing the stroke outside the touch panel when the stroke is estimated to draw a closed region.

16. (canceled)
